(19) United States
(12) Patent Application Publication
(10) Pub. No.: US 2013/0285360 A1
(43) Pub. Date: Oct. 31, 2013

(54) Clever Cover

(71) Applicant: Helen L. Humphries, Inglewood, CA (US)

(72) Inventor: Helen L. Humphries, Inglewood, CA (US)

(21) Appl. No.: 13/459,892

(22) Filed: Apr. 30, 2012

(51) Int. Cl. B42D 3/00

(52) U.S. Cl. 281/31; 281/29

(57) ABSTRACT

The invention provides a novel specially designed book cover for any hard back or soft cover book or ipad or other electronic tablet, features a zippered perimeter and a series of compartments and storage pockets. The Clever Cover is produced in a wide variety of materials ranging from lightweight plastic, vinyl, and soft fabric to fancy suede and leather materials.

### FIELD OF THE INVENTION

The present invention pertains to the field of book accessories, and more specifically to the field of functional book covers.

### BACKGROUND OF THE INVENTION

The prior art has put forth several designs for book covers. Among these are:

US Patent 2003/0230889 to Kenneth D. Baugh describes a binder for supporting a bible. The binder includes a front support member and a lower back support member hingedly aligned with and spaced from the front support member. A first pocket member on the front support member holds the Bible's front cover and the second pocket member on the back support member holds the Bible's back cover. Several other pocket members are attached to the support members for various purposes.

U.S. Pat. No. 383,492 to Robert G. Siemon and Francois Nolot describes the ornamental design for a book cover which includes two front and back support pieces bound together on one side. A zipper encircles the remaining sides of the support pieces enabling the user to close and zip the book cover together. The book and other items within the cover cannot slip out when the cover is closed and zipped.

U.S. Pat. No. 5,219,437 to Marc L. Moor and Jon R. Wyant describes a fabric covered book cover having front and back leafboards and a spine all covered with a fabric material. The spine contains a plurality of longitudinal parallel seams which permit the spine to curl and fit comfortably in a cupped palm of one's hand.

None of these prior art references describe the present invention.

### SUMMARY OF THE INVENTION

It is an object of the present invention to provide a functional and attractive book cover for holding books, journals, day planners, ipads and supplies.

### BRIEF DESCRIPTION OF THE DRAWINGS

FIG. 1 is a perspective view of the present invention in an open position showing a zipper, a notebook and a book slot.

FIG. 2 is a perspective view of the present invention in an open position showing a memo pad, a three ring binder, book marker slots, a slot to hold small miscellaneous items, a highlighter slot, pencil and marker holders, and pen holders.

FIG. 3 is a perspective view of the present invention in a folded position showing its outside covering with a carrying handle and zipper.

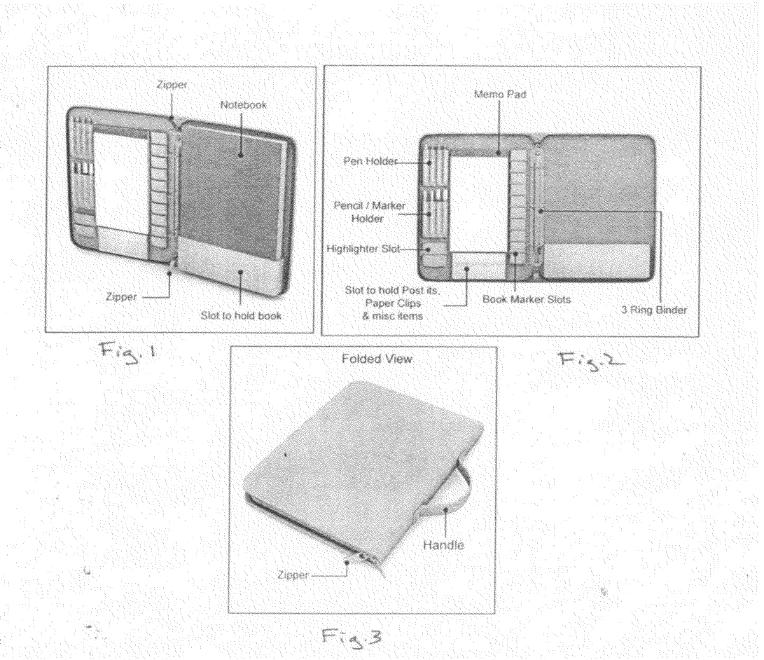

### DETAILED DESCRIPTION OF THE INVENTION

Reading books is a daily occurrence for consumers of all ages. Elementary, middle, high school and college students spend the majority of class time and many hours of free time involved in reading activity. Reviewing class notes, researching information for a report or solving math problems are all activities that involve careful reading of printed material. Although the world has entered the computer age, the simple pleasure associated with leafing through the pages of a printed book still prevails. First edition printings, expensive coffee table books, text books and other material must all be cared for to ensure they retain their value.

The present invention, hereafter referred to as the Clever Cover, is a specially designed book cover for any hard back or soft cover book or ipad or other electronic tablet. The Clever Cover is produced in a wide variety of materials ranging from lightweight plastic, vinyl, and soft fabric to fancy suede and leather materials. This product can be manufactured in a range of sizes to accommodate novels, text books, journals, planners and other books. A standard size of the Clever Cover will measure approximately ten inches in length by eight inches in width. Rectangular in shape, the Clever Covers slips over the front and back cover of the designated book, ensuring a snug fit. A zipper fastener runs the perimeter of the unit, so the user can secure the Clever Cover in a closed position. Incorporated into the Clever Cover is a series of storage compartments for use in securing a variety of supplies or personal goods. In the front cover of the Clever Cover is a hidden panel, easily accessed via a simple pull-tab, on which the user can secure a package of sticky notes, paper clips or other accessories. A series of slotted pocket like holders, designed to accommodate markers, highlighting pens and pencils are included, facilitating a wide variety of storage needs. The Clever Cover is produced in an array of vibrant colors, patterns and printed designs, as well as in basic neutral hues.

Using the Clever Cover is very simple and straight forward. A consumer purchases the Clever Cover in a color, design and size which would best suits their individual taste and needs. The user slides the Clever Cover over the designated book. The user then can utilize the Clever Cover's integrated storage compartments to secure a variety of goods including sticky notes, pens, pencils and paper clips. Items are removed from the Clever Cover as needed with the book cover zipped shut following use. The book's cover and binding are protected from over wear or excessive use. The clever inclusion of various storage pouches and pockets enables consumers to store a variety of items including pens, pencils, highlighters, and sticky notes. The user will always have necessary tools on hand to jot down important notes, highlight pertinent material or underline text.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A functional and attractive book cover device for holding books, journals, day planners, electronic tablets and supplies, comprising: a rectangular cover capable of being slipped over the front and back cover of the designated book, further comprising a zipper fastener running the perimeter of the cover, so the user can secure the cover in a closed position.

2. The cover device of claim 1 further comprising a series of storage compartments for use in securing a variety of supplies or personal goods.

3. The cover device of claim 2, further comprising a hidden panel in the front cover of the device, which hidden compartment is accessed by means of a simple pull-tab, on which the user can secure a package of sticky notes, paper clips or other accessories.

4. The cover device of claim 3 further comprising a series of slotted pocket like holders, designed to accommodate markers, highlighting pens and pencils are included, facilitating a wide variety of storage needs.

5. The cover device of claim 2 produced in an array of vibrant colors, patterns and printed designs, as well as in basic neutral hues.

6. The cover device of claim 2 produced in a variety of materials including, but not limited to lightweight plastic, vinyl, soft fabric, fancy suede and leather materials.

7. The cover device of claim 2 manufactured in a range of sizes to accommodate novels, text books, journals, planners, electronic tablets and other books.

8. The cover device of claim 7 produced in a standard size of measuring approximately ten inches in length by eight inches in width.
